(19) United States
(12) Patent Application Publication
(10) Pub. No.: US 2006/0118479 A1
(43) Pub. Date: Jun. 8, 2006

(54) Particle separating devices, systems, and methods

(76) Inventors: Sergey S. Shevkoplyas, Brighton, MA (US); Lance L. Munn, Lexington, MA (US); Mark W. Bitensky, Waban, MA (US); Tatsuro Yoshida, West Newton, MA (US); Chenghai Sun, Salem, MA (US)

Correspondence Address: FISH & RICHARDSON PC, P.O. BOX 1022, MINNEAPOLIS, MN, 55440-1022, US

(21) Appl. No.: 11/211,000

(22) Filed: Aug. 24, 2005

Related U.S. Application Data
(60) Provisional application No. 60/603,877, filed on Aug. 24, 2004.

(51) Int. Cl. C02F 1/00

(52) U.S. Cl. 210/433.1; 210/767; 209/1; 209/155; 209/208

(57) ABSTRACT

Devices, systems and methods for separating particles are disclosed.

### CROSS REFERENCE TO RELATED APPLICATIONS

This application claims priority from U.S. Provisional Patent Application No. 60/603,877, filed on Aug. 24, 2004, the contents of which is incorporated herein by reference in its entirety.

### STATEMENT AS TO FEDERALLY SPONSORED RESEARCH

This invention was made with Government support under NIH Grant No. R01 HL64240. The Government thus has certain rights in the invention.

### TECHNICAL FIELD

This invention relates to devices, systems, and methods for separating particles.

### BACKGROUND

It is often desirable to separate different types of particles from each other in suspensions. For example, many assays or applications use enriched samples of red or white blood cells. Whole blood is mostly plasma, but it also includes particles such as its three major cellular components: red blood cells (RBCs, erythrocytes), white blood cells (WBCs, leukocytes) and platelets. RBCs are commonly 1000 times more abundant than WBCs. Such highly concentrated particulate suspensions exhibit unique flow characteristics (see, for example, Goldsmith et al., Am. J. Physiol. 257, H1005-H1015 (1989)).

Separation and identification of components in a blood sample are useful a diagnostic tools in medicine, e.g., to determine disease state, e.g., anemia and leukemia. Since WBCs contain genetic material, e.g., DNA and RNA, it is often useful to separate WBCs from the rest of the whole blood to analyze this genetic material.

### SUMMARY

In general, the invention relates to devices, systems, and methods for separating particles of different physical dimensions, e.g., cellular components of blood (e.g., white blood cells, red blood cells, and platelets), polymeric particles, inorganic particles (e.g., ceramics or metals), biological particles (e.g., plasmids, proteins, cells, or nucleic acids, e.g., DNA, RNA, or other macromolecules), from each other. Particles of all types suspended in a liquid, e.g., water, water made viscous by adding a soluble polymer, an alcohol, a hydrocarbon solvent, an acetate solvent, or a chlorinated solvent, can be separated from each other by creating microfluidic devices and/or systems having appropriate dimensions and configurations that cause the particles to separate from each other.

“Particles” can be of any shape, e.g., oblong, spherical, or disk-like. Generally, the particles range in size, e.g., have a maximum dimension, from about 30 nm to about 100 μm, e.g., from about 30 nm to about 200 nm, from about 200 nm to about 500 nm, from about 500 nm to about 1000 nm (1 μm), from about 1 μm to about 20 μm, or from about 20 μm to about 100 μm.

“Separating” is meant to include fully separating, partially separating, sorting, segregating, and extracting. Concentrating one particle in a liquid with respect to another also falls within the definition of separating as used herein.

“Under pressure” is meant to include any force that is applied to cause a liquid to move through a device or a system, including, for example, gravity, hydrostatic pressure, centrifugal force, vacuum (e.g., vacuum generated from a pipette), and pressure created by a pumping mechanism.

“Blood products” include, but are not limited to, whole blood, plasma, serum, cells such as red blood cells and white blood cells, and platelets.

Different types of particles, e.g., RBCs and WBCs, can be efficiently separated from each other by the microfluidic devices and/or systems whose dimensions and configurations cause the particles to separate from each other by one or more physical phenomenon. Without wishing to be bound to theory, we believe that these physical phenomenon include margination, skimming, velocity differences, and/or dynamic pressure differential modulation.

In some embodiments, the devices and/or systems described herein include flow paths that are configured such that margination of one particle type occurs towards walls of a first flow path. A second flow path is configured to capture these marginated particles.

In other embodiments, flow paths are arranged such that some of the flow paths are in fluid communication through an aperture or apertures defined in a barrier. Faster, smaller particles accumulate immediately upstream from the larger, slower particles in a channel. Passage of the larger particles into a segment downstream of an aperture causes an increased flow resistance in that segment and diversion of flow through the aperture into an adjacent channel. This results in removal of faster, smaller particles that are following the large, slower particle.

Particles of all types suspended in a liquid can be separated from each other using the devices, systems, and methods disclosed herein.

For example, different size viruses or bacteria can be separated from each other, and different size DNA or RNA molecules can be separated from each other. Different size proteins, e.g., prions, can be separated from each other, and inorganic particles, e.g., ceramic particles, can be separated from each other. Polymeric particles, e.g., degradable or non-degradable polymeric particles, can be separated from each other. Cells, e.g., RBCs, WBCs, platelets and rare cells, can be separated from each other. Rare cells include, e.g., stem cells (e.g., cancer stem cells) and fetal cells. Cancer stem cells have been described by Travis, Science News 165 (12), 184 (2004).

In one aspect, the invention features devices for separating first particles from a suspension of particles in a liquid. The devices include a first flow path defined by a first pair of walls through which the suspension of particles in the liquid may flow, and a second flow path defined by a second pair of walls that is in fluid communication with the first flow path. The first flow path is configured and dimensioned such that margination of the first particles occurs towards the first pair of walls, and the second flow path is configured to capture the marginated first particles.

In some embodiments, a distance from a start of the first flow path to a start of the second flow path is from about 100 μm to about 25 cm.

A width of the first flow path, measured between the first pair of walls can be, e.g., from about 10 μm to about 10 mm.

A height of the first flow path, measured from a ceiling to a floor of the first flow path, can be, e.g., up to 75% larger than a largest outside dimension of a first particle or up to 25% smaller than a largest outside dimension of the first particle when the particle is compressible. In a particular embodiment, a height of the first flow path is substantially equivalent to a largest outside dimension of a first particle.

A width of the second flow path, measured between the second pair of walls, can be, e.g., within 20% of a largest outside dimension of a first particle.

In some embodiments, the first flow path and/or second flow path is substantially straight along its entire length.

In some embodiments, the first flow path and/or the second flow path includes a turn along a portion of its length.

The first flow path can include a bend of from about 90 to about 180 degrees, measured from a central longitudinal axis of the flow path upstream and downstream of the bend.

A flow path can include, e.g., a projection, e.g., that is circular in cross-section when viewed from above. The projection can, e.g., bifurcate the flow path.

In some embodiments, an upstream portion of one of the second pair of walls of the second flow path tapers, forming a tip, e.g., a sharp tip, proximate an entrance of the second flow path.

One of the second pair of walls of the second flow path can, e.g., include an aperture defined therethrough such that the first flow path and the second flow path are in fluid communication through the aperture. In some embodiments, the second flow path includes a constriction in which a width of the second flow path narrows from an upstream portion to a downstream portion. For example, the second flow path includes a constriction in which a width of the second flow path narrows continuously from a nominal width at an upstream portion to a minimum width, and then widens back to the nominal width of the second flow path at a downstream portion. The constriction can, e.g., be proximate an aperature.

The flow paths can be, e.g., formed in a substrate that includes a polymeric material, e.g., a poly(siloxane).

In another aspect, the invention features devices and/or systems for separating cells from blood products, including a plurality of devices just described arranged in series, such that a first flow path of each device is in fluid communication with a first flow path of an adjacent device, and a second flow path of each device is in fluid communication with a second flow path of an adjacent device.

In another aspect, the invention features devices and/or systems for separating blood that include a plurality of devices just described arranged in parallel.

In another aspect, the invention features devices for separating first particles from a suspension of particles in a liquid. The devices include a first flow path through which the suspension of particles may flow; a second flow path that is in fluid communication with the first flow path; and a barrier that separates the first and second flow paths including an aperture defined therein that is configured to exclude the first particles. The first flow path is has a height, measured from a ceiling to a floor of the first flow path and a width, measured between walls of the first flow path that is, e.g., up to 75% larger than a largest outside dimension of the first particles.

In some embodiments, the barrier includes a plurality of apertures.

In another aspect, the invention features devices for separating a liquid from particles suspended in the liquid that include a first flow path defined by a first pair of walls through which particles suspended in the liquid may flow, and a plurality of second flow paths extending from walls of the first flow path, each second flow path defined by a second pair of walls. Each second flow path is in fluid communication with the first flow path, and each second flow path has a width, measured between the second pair of walls, that is smaller than a dimension of a smallest particle in the suspension.

In another aspect, the invention features methods for separating first particles from a suspension of particles in a liquid using any of the devices and/or systems described herein. For example, the liquid can be blood plasma, and the first particles can be white blood cells.

In another aspect, the invention features methods of separating a liquid from a suspension of particles in the liquid using any of the devices and/or systems described herein. For example, the liquid can be blood plasma, and the particles can be cellular components of blood.

The devices and/or systems described herein can be used, for example, in “lab-on-a-chip” microanalytical devices and/or methods. The devices and/or systems can provide an inexpensive, portable, and miniaturized tool, e.g., that occupies less than 10 mm² of space. The devices, systems, and methods require only a small amount of sample, e.g., blood, e.g., sometimes less than 50 μl, 10 μl, or even less than 1 μl. The devices and/or systems described herein can be used in analysis of WBCs, or their genetic material, e.g., DNA, or RNA. The devices and/or systems, in some embodiments, have no electrically or mechanically active structural elements, require only a small hydrostatic pressure gradient to function, e.g., sometimes less than 150 cm H₂O, and can be manufactured by known microfabrication techniques, for example, soft photolithography, silicon micromachining, or polymer replica molding.

When used to separate blood constituents, the devices and/or systems can operate on (anti-coagulated) whole blood, actually benefiting from the same factors, e.g., high cell concentration, or cell-cell interactions, that can confound other sample preparation techniques. For example, the devices and/or systems, in certain embodiments, provide positive, continuous flow selection. That is to say that blood, e.g., cellular components, are not trapped in any specific area of the device and/or system, but continue to flow in the device and/or system, and can be conveniently transported to analytical units or for further purification, e.g., disposed elsewhere on a chip.

When used to separate blood constituents, the devices and/or systems require minimum white blood cell handling, reducing white blood cell activation and damage. Other than the possible addition of an anti-coagulant, e.g., EDTA or heparin, no pre-processing of whole blood is typically needed prior to using the new devices and/or systems, e.g., no preliminary labeling of white blood cells is generally needed. The separation or concentration is efficient, e.g., producing, in some embodiments, greater than a 34-fold increase in the WBC-to-RBC ratio in a single pass. In other embodiments, a 68-fold enrichment of the WBC-to-RBC ratio can be achieved. In some configurations, systems can be used for complete separation of whole blood constituents into individual components, e.g., creating a stream of substantially pure WBCs, RBCs, and a stream of substantially pure platelets.

In other embodiments, particles can be separated from each other for manufacturing purposes. For example, different size fragments of DNA can be separated from each other, e.g., fractionated. Also, for example, polydisperse inorganic particles, e.g., ceramic particles, or polydisperse polymeric particles, e.g., degradable or non-degradable polymeric particles, can be separated, e.g., fractionated, from each other to prepare particles having a monodisperse, or nearly a monodisperse size distribution.

Many of the particle separation devices and/or systems described herein can be constructed in series, e.g., to further improve the efficiency, or in parallel, e.g., to increase the yield of separation.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1A is a schematic top view of a device prior to substantial margination of white blood cells.

FIG. 1B is a cross-sectional view of the device shown in FIG. 1A, taken along line 1B-1B.

FIG. 1C is a cross-sectional view of the device shown in FIG. 1A, taken along line 1C-1C.

FIG. 2 is a schematic top view of the device shown in FIG. 1A later in time, illustrating extraction of white blood cells after margination.

FIG. 3 is a schematic top view of a device, illustrating a flow path bifurcated by a projection.

FIG. 4 is a schematic top view of a device including a plurality of relatively densely packed projections resulting in higher inlet pressures (relative to FIG. 5) in a flow path.

FIG. 5 is a schematic top view of a device including a plurality of relatively loosely packed projections resulting in lower inlet pressures (relative to FIG. 4) in a flow path.

FIG. 6A is a top view of a transparent microfluidic device that includes a number of interconnected flow paths.

FIGS. 6B-6E are a series of bar graphs that illustrate varying degrees of white blood cell margination along the initial straight flow path of the device shown in FIG. 6A.

FIGS. 6F and 6G are schematic representations of blood flowing through the device of FIG. 6A at different locations in the device.

FIG. 7 is a schematic top view of a device in which a first flow path and a second flow path are in fluid communication through an aperture defined in a barrier that is configured to exclude white blood cells.

FIG. 8 is a schematic top view of a another device having an aperture configured to exclude white blood cells.

FIG. 9 is a schematic top view of a device having two aperture configured to exclude white blood cells.

FIG. 10 is a schematic side view of a method of making microfluidic devices.

FIG. 11 is a schematic top view of a system for separating blood components using principles illustrated in FIGS. 1-6G FIG. 12A is a schematic top view of a system for separating blood components that includes a concentrator.

FIG. 12B is an enlarged view of area 12B shown in FIG. 12A.

FIG. 12C is a schematic top view of a device for separating platelets from a stream including RBCs, platelets and blood plasma.

FIG. 12D is a representation of a portion of the device shown in FIG. 12C in operation.

FIG. 12E is a cross-sectional view of the device of FIG. 12C, taken along line 12E-12E.

FIG. 13A is a schematic top view of a system according to another embodiment.

FIG. 13B is an enlarged view of area 13B shown in FIG. 13A.

FIG. 13C is a schematic top view of a system that can concurrently separate, image and analyze.

FIG. 14 is a schematic view of an apparatus for real-time viewing of blood as it moves through a microfluidic device and/or system.

FIG. 14A is an enlarged view of area 14A shown in FIG. 14.

FIG. 15A is a schematic top view of a device having an aperture configured to remove red blood cells from a mixture of blood components.

FIG. 15B is a representation of a portion of the device of FIG. 15A during operation.

Like reference symbols in the various drawings indicate like elements.

### DETAILED DESCRIPTION

In general, devices, systems, and methods for separating particles are disclosed. Particles include, for example, polymeric particles, inorganic particles (e.g., ceramics or metals), biological particles (e.g., plasmids, proteins, cells, prions, or nucleic acids, e.g., DNA or RNA). Specific particles include components of blood, e.g., RBCs, WBCs, and platelets. The liquid in which the particles are suspended can be polar, e.g., dimethyl sulfoxide, or chloroform, or non-polar, e.g., hexane, or carbon tetrachloride. The liquid can be, e.g., plasma, water, water made viscous by adding a soluble polymer, an alcohol, an ether, a sulfoxide, an organic acid, a ketone, an acetate, a nitrile, a hydrocarbon solvent, or a chlorinated solvent.

Various microfluidic devices for separating particles are described herein. RBCs and WBCs are often used as non-limiting examples of the types of particles that can be separated.

General Methodology—Margination

In general, some of the devices and/or systems described herein include flow paths that are configured and dimensioned such that margination of particles, e.g., WBCs, occurs toward sidewalls of a flow path. Other flow paths are configured to capture the marginated particles. Without wishing to be bound by any particular theory, it is believed that by configuring and dimensioning flow paths appropriately, e.g., by providing a height of a flow path that is no larger than twice the largest outside dimension of the particle, e.g., a WBC, a polymeric particle, an inorganic particle (e.g., a ceramic or a metal), and, in some cases, no smaller than the particle, e.g., WBC diameter, encourages migration of the particles towards walls of a flow path where they can be sequestered and captured by other flow paths. It is believed that this occurs due to directed random migration of the particles, e.g., WBCs, towards a wall upon frequent collision with other particles, e.g., RBCs.

Without wishing to be bound by any particular theory, it believed that with respect to the WBCs, the mechanism of margination can be explained as follows. Confined by top and bottom walls, the WBCs flow near the center of a channel (viewed from side) and occupy a large cross-section of the parabolic flow profile. The flat and smaller RBCs can occupy less cross-sectional area in the parabolic flow profile, and also may flow near a center as well, e.g., near the top and bottom walls. Therefore, relative to the WBCs, the RBCs have a much wider range of velocities. The RBCs at the center are faster than the WBCs and the RBCs near the top and the bottom walls are slower than the WBCs. Due to the frequent collisions with RBCs, the WBCs migrate laterally. Once WBCs are in the proximity of a sidewall, they are trapped there by the flow and flow slowly parallel to the wall. The size ratio of the two species of particles can be important for the margination of the WBCs. For example, if the solution consists of only platelets and WBCs (e.g., the solution contains no or few RBCs), one may expect less margination of WBCs. This mechanism of margination operates similarly for any pair of species of particles in which one type of particle is, e.g., about 1.5 to about 4 times larger than the other type of particle.

While being trapped near the walls, WBCs move more slowly than the rest of the blood stream. Therefore, WBCs gradually accumulate along the flow pathway, resulting in a gradual increase of the overall WBC concentration in that segment of the flow pathway along the walls.

Sequestering the WBCs near the wall may be enhanced by coating inner surfaces of the channels with adhesion molecules that have complementary receptors to those on the cell of interest. This can be used, for example, to isolate leukocyte subtypes based on cell adhesion molecule expression. The surface density of adhesion receptors, e.g., P-selectin (e.g., soluble, recombinant P-selectin), or E-selectin within a channel can be optimized to encourage cell rolling into the extraction channels, while discouraging firm adhesion of the WBCs.

During the coating process, the adhesion molecules can be chemically bonded (e.g., covalently bonded), or physically bonded (e.g., adsorbed), onto surfaces of the desired channels. For example, soluble P-selectin can be adsorbed onto surfaces of channels by first diluting P-selectin to the desired coating concentration, e.g., 10 μg/mL, in binding buffer (e.g., 0.1 M NaHCO₃, pH 9.2), filling the channels with the diluted solution, and then incubating (e.g., for 2-8 hours). After incubation, channel surfaces are washed with Dulbecco's phosphate-buffered saline (pH 7.4) containing calcium and magnesium ions. After washing, the channels are infused with a solution of heat-denatured bovine serum albumin (2%), and then incubated (e.g., for 30 minutes). Additional details of coating adhesion molecules onto surfaces are described Rodgers, Biophysical Journal 79, 694-706 (2000) and Eniola, Biophysical Journal 85, 2720-2731 (2003).

General Methodology—Sorting

Other devices and/or systems include flow paths that are arranged such that some of the flow paths are in fluid communication through an aperture or apertures defined in a barrier that separates flow paths. The aperture or apertures are sized to exclude one type of particle, e.g., WBCs, while allowing another type of particle, e.g., RBCs to pass through. Without wishing to be bound by any particular theory, it is believed that configuring and dimensioning the aperture(s) and dimensions of the flow paths appropriately, e.g., by configuring the pathways so that faster RBCs accumulate behind a flowing WBC. The increase in flow resistance in that channel introduced by the WBC then diverts flow of the tailing RBCs to the parallel channel(s).

Still other devices and/or systems described herein include flow paths arranged such that some flow paths are configured to exclude white and RBCs, while allowing blood plasma and any suspended constituents, e.g., platelets, of smaller size to continue on those paths.

The above devices can be fashioned into systems configured to separate whole blood into fractions containing a highly enriched concentration of an individual cellular component of interest or a combination of the components, e.g., WBCs, RBCs, or platelets suspended in plasma, or containing blood plasma highly depleted of the components.

Individual Devices

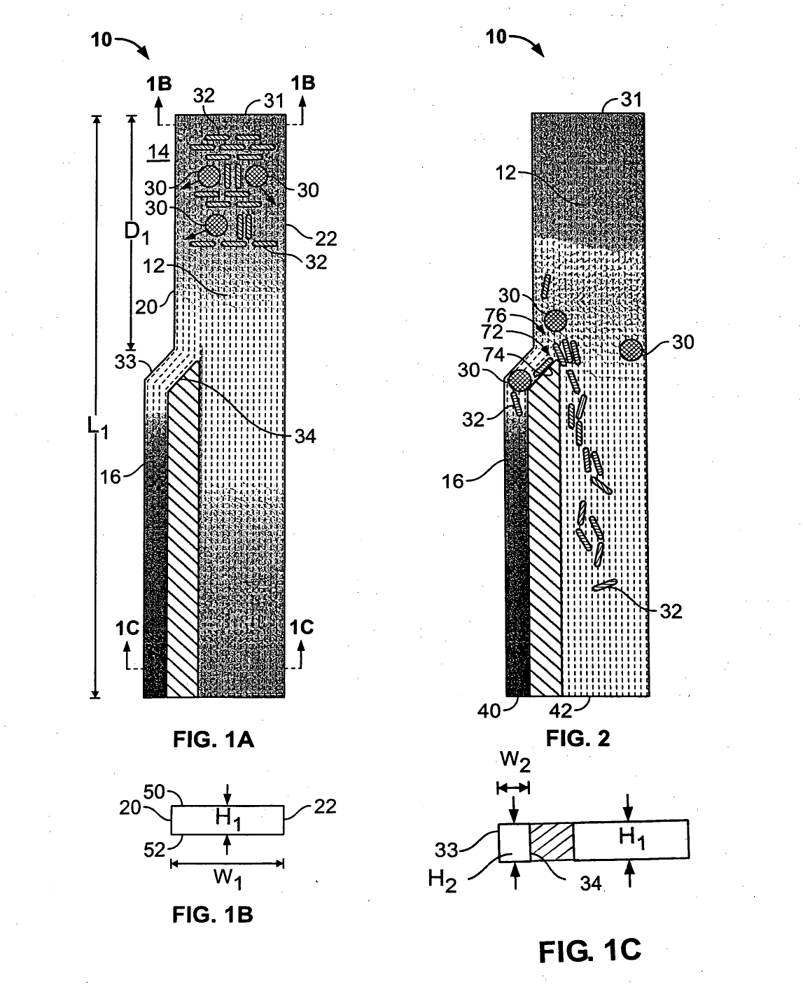

Referring to FIG. 1A, a device 10 for separating WBCs from blood includes a first flow path 12 that is defined by a first pair of walls 20, 22 in a substrate 14 through which blood may flow in response to a pressure differential. Device 10 also includes a second flow path 16 that is in fluid communication with first flow path 12, the second flow path being defined by a second pair of walls 33, 34. First flow path 12 is configured and dimensioned such that margination of WBCs 30 occurs toward the first pair of walls 20, 22 (as shown by arrows), and second flow path 16 is configured and dimensioned to capture the marginated WBCs 30.

FIG. 2 illustrates device 10 at a somewhat latter time relative to FIG. 1A, e.g., 0.1 second later, so that collectively FIGS. 1A and 2 show margination of WBCs 30, and the capture of WBCs 30 by second flow path 16. Blood that includes red cells 32 and white cells 30 enters an inlet 31 of device 10, and travels along first flow path 12 for a sufficient distance such that margination of WBCs 30 occurs. Some of the marginated WBCs 30 are captured by second flow path 16 such that blood exiting outlet 40 is enriched with WBCs 30 relative to blood entering inlet 31, while blood exiting outlet 42 of the first flow path 12 is depleted of WBCs relative to blood entering inlet 31. It is believed that configuring and dimensioning the flow paths appropriately, as will be discussed in greater detail below, encourages RBCs 32, e.g., with a largest outer dimension of from about 6 μm to about 8 μm, to flow down a central portion of flow path 12, while encouraging margination of WBCs 30, e.g., with a largest outer dimension of from about 8 μm to about 12 μm, towards walls 20, 22 of first flow path 12, where they are diverted to or captured by second flow path 16.

Referring particularly to FIG. 1A, a distance D₁ from the inlet 31 of the first flow path 12 to a start of the second flow path 16 is sufficient to allow margination of WBCs 30 to occur towards walls 20, 22. In some instances, the distance is, for example, from about 0.5 mm to about 10 mm, e.g., 1 mm, 2 mm, 5 mm, or 8 mm. The minimum distance that is needed to achieve margination depends generally on the blood flow rate in the flow path 12, and in particular on the pressure differential, the initial concentration of RBCs, plasma viscosity and composition, height of the flow path 12, and/or activation state of the WBCs. However, the higher limit of this margination distance is not bound in that the larger D₁, the higher expected margination. On the other hand, if this distance becomes excessively long, then because of the accumulation of the WBCs near the sidewalls, and therefore increased interactions between the white cells, some of the white cells might re-enter the central region of the blood stream. In some embodiments, a length L₁ of entire device is, e.g., less than 10 cm, e.g., less than 8, 5, 1, or less than 1 mm.

Referring particularly to FIG. 1B, in some embodiments a width W₁ of the first flow path 12, measured between walls 20, 22 is, for example, from about 10 μm to about 5000 μm, e.g., 25, 100, 200, 500, 750, 1000, 2500, or 4000 μm, and depends on the size of particles to be separated. A height H₁ of first flow path 12, measured from a ceiling 50 to a floor 52 is such that margination of WBCs 30 occurs toward walls 20, 22. For example, H₁ can be up to 75% larger, e.g., 50%, 30% or 20% larger than a largest outside dimension of a WBC 30 or other particle, or up to about 30% smaller, e.g., 20%, or 10% smaller than the largest outside dimension (when the particle is compressible). Generally, for healthy human cells, the largest outside dimension, e.g., a diameter, of a WBC is from about 8 to about 12 μm. In certain implementations, H₁ is within about 10% (typically, larger, but can be smaller if the particle can be compressed to some degree) of a largest outside dimension of a WBC 30. Under specific circumstances, H₁ is substantially equivalent to a largest outside dimension of a WBC 30, e.g., about 10 μm to 12 μm. In a specific embodiment, H₁ is up to about 75% larger, e.g., 50%, 30% or 20% larger than an average diameter of the WBCs.

Referring particularly to FIG. 1C, a width W₂ of second flow path 16, measured between walls 33, 34 is sized to capture and transport WBCs 30. In some implementations, W₂ is within 30%, 20%, or 10% (either larger or smaller) of a largest outside dimension of a WBC 30. Under some specific embodiments, W₂ is substantially equivalent to a largest outside dimension of a WBC.

A height H₂ of the second flow path 16, in some embodiments, is the same as the height H₁ of the first flow path 12. In some cases, variation of the height may be beneficial. For example, in a purification device with multiple apertures, such as that shown in FIG. 9 (described later), height variation of the upper path may help control the pressure distribution between apertures. An increase in the upper path height by 2-10 fold should increase the pressure difference between the lower and upper paths at the apertures.

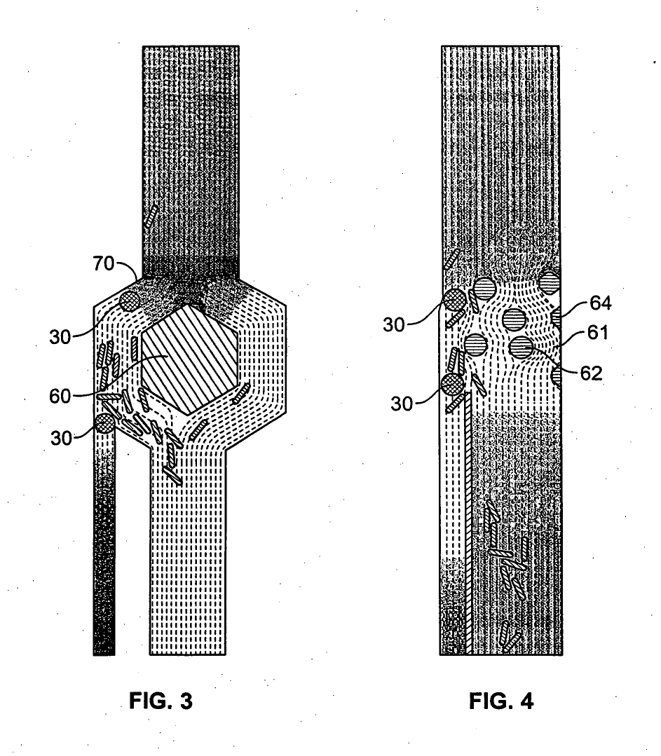

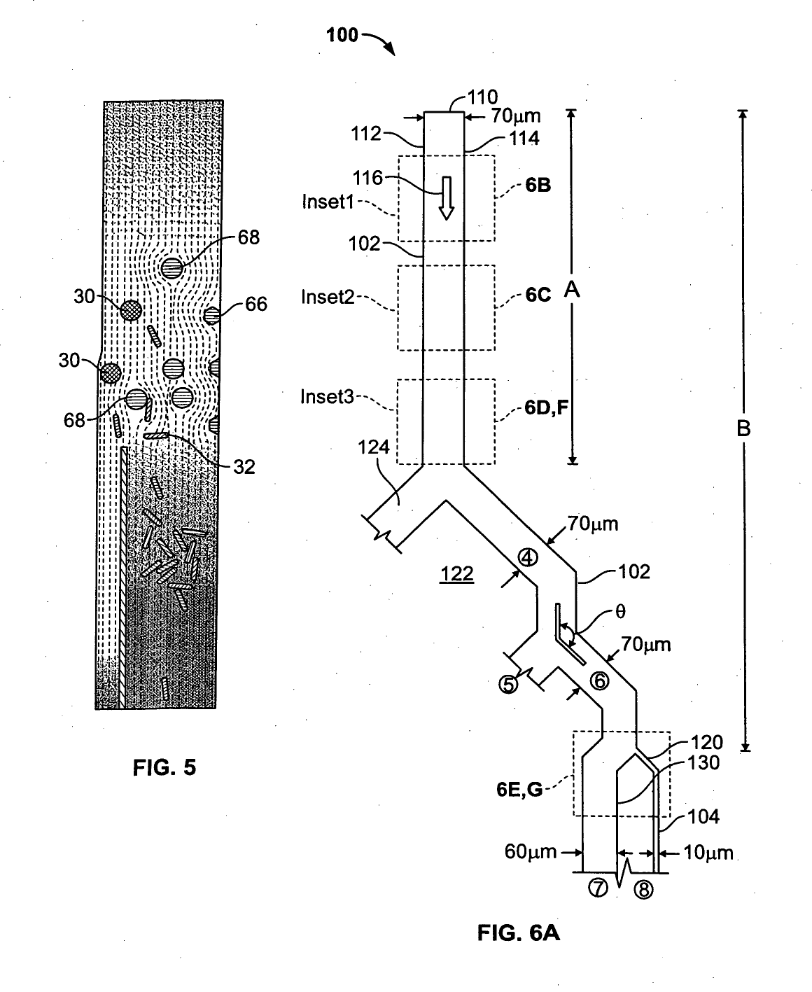

Referring to FIGS. 3-5, a flow path, for example, first flow path 12, can include a projection, for example, to locally change the direction of a velocity vector, for example, vector 61 of FIG. 4, proximate the projection. Examples of projections include, projection 60 of FIG. 3, central projections 62 and wall projections 64 of FIG. 4, and wall projections 66 and central projections 68 of FIG. 5. In some implementations, the projections extend from floor 52 to ceiling 50 of first flow path 12. In particular embodiments, the projections are, e.g., circular in cross-section, or rectangular in cross-section when viewed from above. In some instances, for example, when it is desired to increase the rate of margination, a projection is rectangular in cross-section when viewed from above, and is angled relative to a wall of the flow path. Such a specific embodiment will be described in further detail below.

Velocity and separation efficiency can be changed by changing the density of the projections in a flow path. Increasing projection density, for example, changing from the embodiment of FIG. 5 to the embodiment of FIG. 4, generally tends to increase flow pressures. Relative flow pressure in FIGS. 1-5 is shown by shading, where darker shading indicates a higher relative pressure. The projections can play two roles. First, they divert WBCs and direct random migration of WBCs towards sidewall(s), thus enhancing WBC margination, while allowing RBCs to flow between them. Second, they can induce a high-pressure drop across them, so that the pressure downstream of the projections is lower than that in a branch, often resulting in a higher concentration of WBCs in the branch.

In some embodiments, first flow path 12 is substantially straight along its entire length, for example, those embodiments of FIGS. 1, 2, 4, and 5. In other instances, for example, when it is desired to perturb a velocity vector to increase the extraction efficiency, a flow path, e.g., first flow path 12 and/or second flow path 16, can include turns along portions of its length.

Referring particularly to FIG. 3, projection 60 bifurcates first flow path 12, thereby defining a third flow path 70. Such a bifurcation can be advantageous to increase separation efficiency.

In certain implementations (e.g., the embodiment of FIG. 2), an upstream wall 72 of second flow path 16 tapers, forming a sharp tip 74 proximate an entrance 76 of second flow path 16. This tapering can be advantageous in capturing marginated WBCs.

In many of the embodiments described herein, a high enrichment is possible using a small pressure gradient between the inlet channel and final extraction channel. In certain embodiments, the pressure gradient is, e.g., less than about 1000 cm H₂O, e.g., less than 750, 500, 300, 150, 100, 50, 20, 10 or even less than 5 cm H₂O.

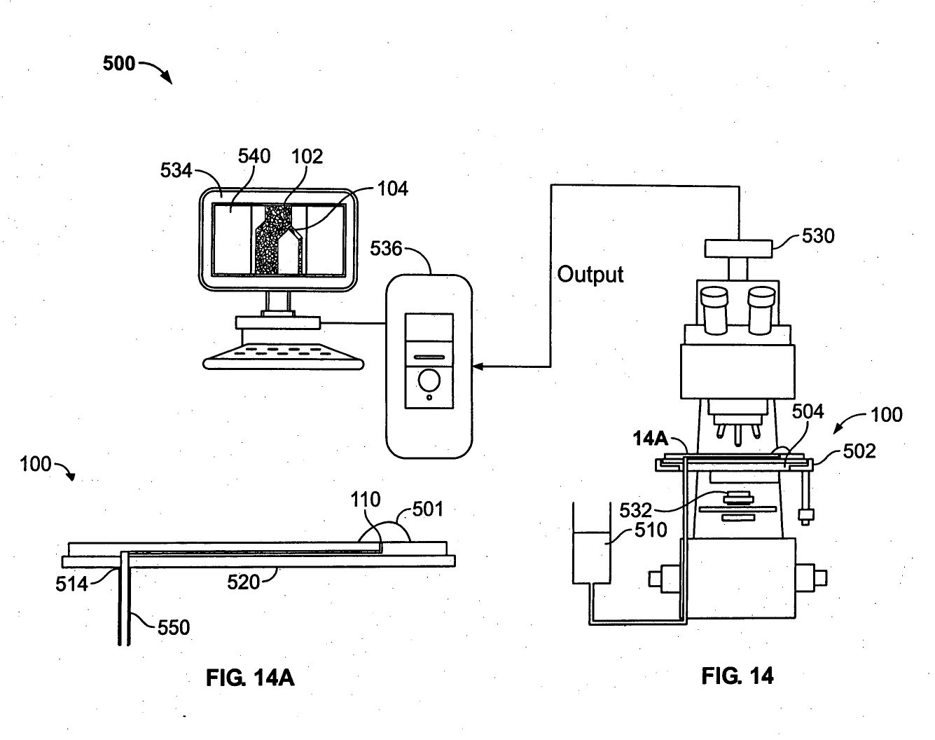

Pressure can be generated, for example, by applying pressure using a pump on an inlet of a device or system, by applying a vacuum at an outlet of the device or system (e.g., using a pipette), or by applying centrifugal force to the device or system. Pressure can also be generated, for example, hydrostatically by employing a reservoir of fluid (like shown in FIG. 14).

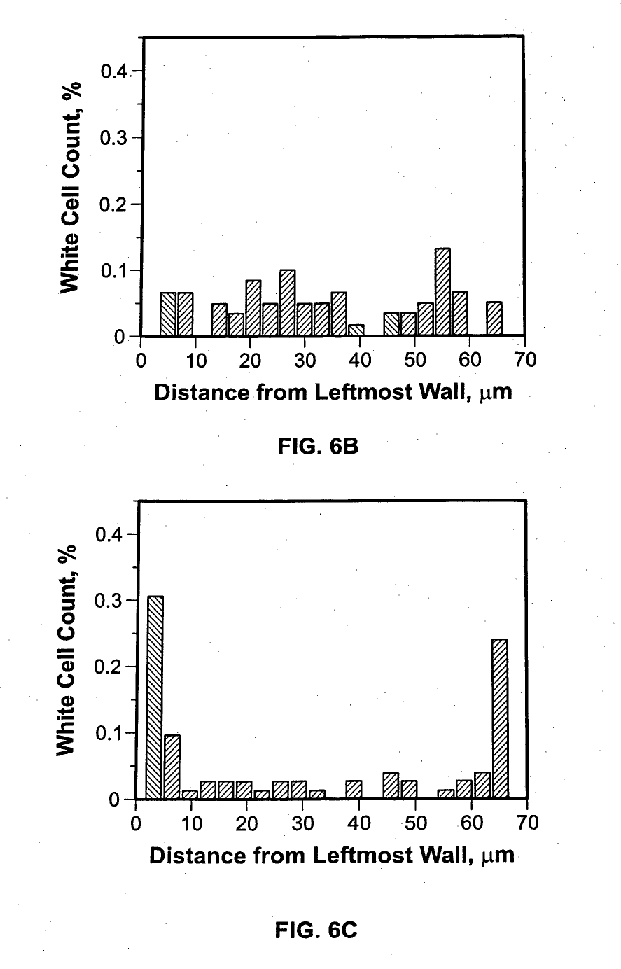

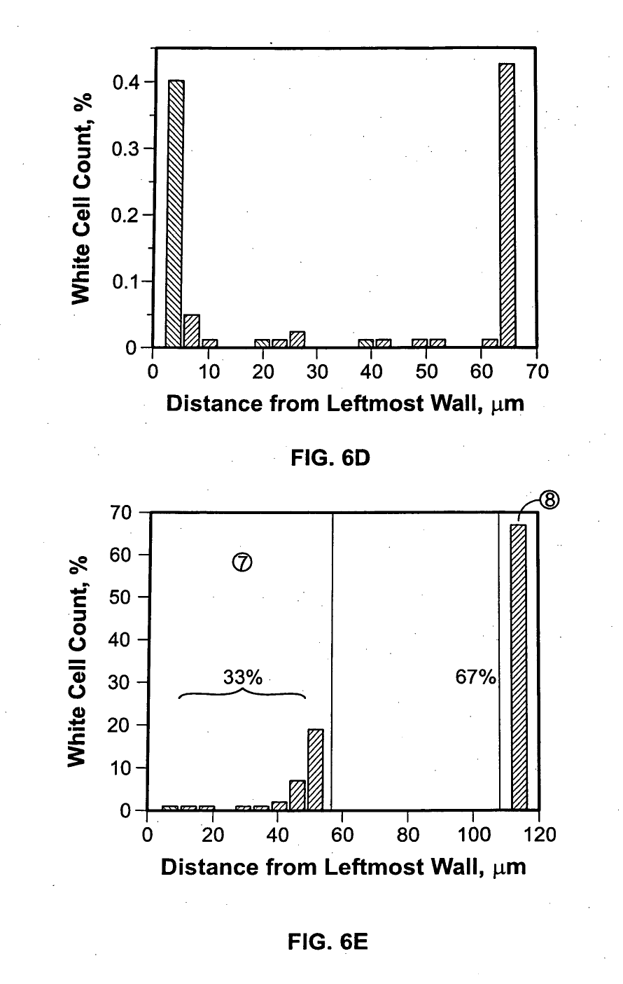

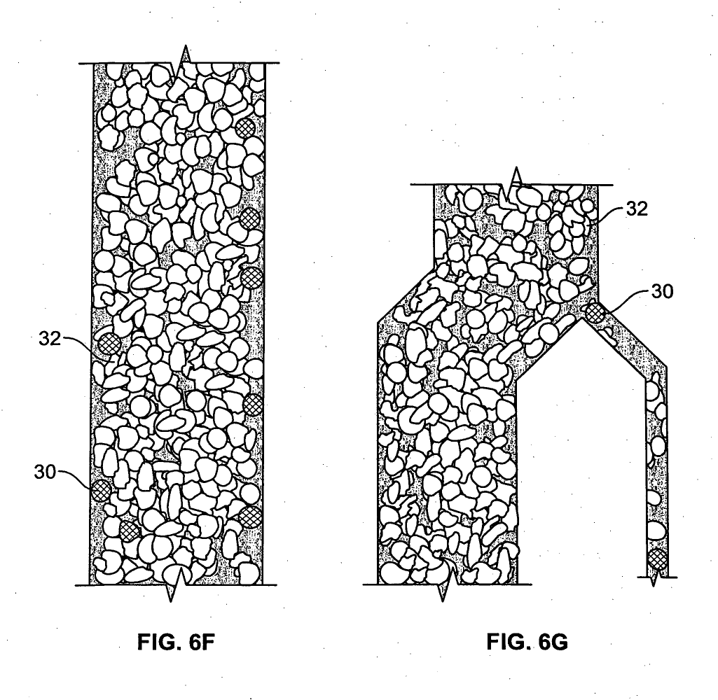

In a particular embodiment illustrated in FIG. 6A, a device 100 for separating white blood cells from blood have an overall length of approximately 10 mm. Blood enters device 100 through inlet 110. Device 100 includes a first flow path 102 and a second flow path 104 that is in fluid communication with first flow path 102. A beginning 120 of the second flow path 104 occurs at a distance B of approximately 7 mm from inlet 110. First flow path 102 is a tortuous path that includes turns and is configured and dimensioned such that margination of white blood cells occurs along flow path 102 (starting from inlet 110). Second flow path 104 is configured and dimensioned to capture the marginated WBCs. Specifically, whole blood with randomly distributed WBCs 30 enters device 100 through an inlet 110 that is 70 μm wide, measured between side walls 112, 114. A height of all flow paths in device 100 is 10.3 μm, or approximately the same diameter of a typical WBC. Whole blood samples enter the device via inlet 110 connected to a feeding reservoir. In the feeding reservoir, the concentration of WBCs is approximately 4,300 WBCs/μL. As the smaller, more flexible RBCs 32 seek the faster central flow region 116, they collide with WBCs 30 eventually forcing the WBCs outward towards walls 112, 114, where WBCs become trapped. Progressively more margination of WBCs 30 occurs along the first, straight part of flow path 102. Determination of a degree of margination of WBCs and concentration of WBCs at a particular flow path location is described in the Examples.

Referring to Inset 1 (and associated FIG. 6B), immediately after entering device via inlet 110, the white blood cell concentration is approximately 2,100 WBCs/μL, which is almost two times lower than the initial WBCs concentration in the whole blood sample. This effect is caused by the indirect sample introduction method of this particular embodiment. Providing for a direct inflow of whole blood into device 100 can eliminate this WBC concentration reduction, and increase the final efficiency of separation two-fold. WBCs enter device 100 through inlet 110 distributed nearly uniformly across the width of flow path 102.

Referring to Inset 2 (and associated FIG. 6C), after traveling a length of approximately 3 mm, WBC concentration along walls is approximately 3,500 WBCs/μL, and margination is well under way, as shown by high WBC counts near walls 114, 116 in FIG. 6C.

Referring to Inset 3 (and associated FIGS. 6D and 6F), after traveling a length of approximately 6.5 mm, WBC concentration along walls is approximately 4,500 WBCs/μL, and margination is nearly complete, as shown by high WBC counts near walls 114, 116 in FIG. 6D. Because a velocity near a wall is lower, the concentration of WBCs increases along the straight part of first flow path 102. A flux balance shows that a theoretical maximum concentration (C) ratio between any two points along the first flow path is determined by the relative average velocity (v) of the WBCs, C₂/C₁=v₁/v₂. In this particular case, for the straight portion of the first flow path, ratio is approximately 2 (4500/2100 WBCs/μL, Insets 1 and 3, FIGS. 6B and 6D, respectively).

After a distance A of approximately 7 mm, the first flow path 102 is bifurcated for the first time with a projection 122 in flow path 102. Part of the mass of blood continues along first flow path 102, and part of the mass of blood follows a third flow path 124. After passing through bifurcation 122, each daughter channel (continuation of first flow path 102 and third flow path 124) has approximately equivalent WBC concentration profiles with most of the WBCs traveling near the continuations of the original sidewalls 112 and 114 of flow path 102. Either or both can be used for further processing. The WBC concentration profiles across flow paths 124 and 102 can be envisioned as left-hand half and right-hand half of the distribution shown in FIG. 6D, respectively.

The asymmetry in WBC concentration at point (4) causes most of the WBCs to enter segment (6), which is a continuation of flow path 102, rather than segment (5). The blood entering segment (5) contains a highly enriched suspension of RBCs. The first flow path 102 bends prior to point (6), e.g., with an angle θ of between about 90° and 160°, and shown in this particular embodiment, 135°. The turn alters the velocity profile causing RBCs to move quickly around the inside (leftmost wall of segment (6)), bypassing the WBCs that travel more slowly in the plasma-rich region near outer sidewall 114 of flow path 102. As the RBCs pass the slower WBCs, they tend to trap the WBCs near a wall and encourage the WBCs into the second flow path 104, which is the extraction channel. Approximately 67% of the WBCs from segment (6) enter the second flow path 104, while the others continue along a right-hand sidewall 130 of segment (7). The overall concentration of WBCs at point (7) is approximately 2,500 WBCs/μL, with distribution across the flow path shown graphically in FIG. 6E, and pictorially in FIG. 6G.

The white blood cell concentration in second flow path 104 at point 8 is approximately 42,300 WBCs/μL, or approximately an order of magnitude higher than in the original whole blood sample in the feeding reservoir connected to inlet 110.

Both white blood cell margination and plasma skimming appear to be important determinants of the blood composition in segment (8). Accumulation of white blood cells near sidewalls 112 and 114 in the plasma rich region causes eventually two-thirds of the white blood cells to enter the second flow path 104 (segment (8)). At the same time, plasma skimming reduces the RBC concentration at point (8) to less than one-third of its initial value in the feeding reservoir. The net effect of the passage of the whole blood sample through device 100 is an increase in the WBC-to-RBC ratio from 1:1100 in a whole blood sample to 1:32 in second flow path 104 at point 8, a thirty-four-fold enrichment. This final enrichment can be doubled, e.g., increased to a 68-fold enrichment, if a direct inflow of whole blood into device 100 is provided.

While the embodiments described directly above require margination, some embodiments do not require WBC margination to separate WBCs from the rest of the blood, but rather employ other flow properties of blood and rheologic principles to obtain a high enrichment.

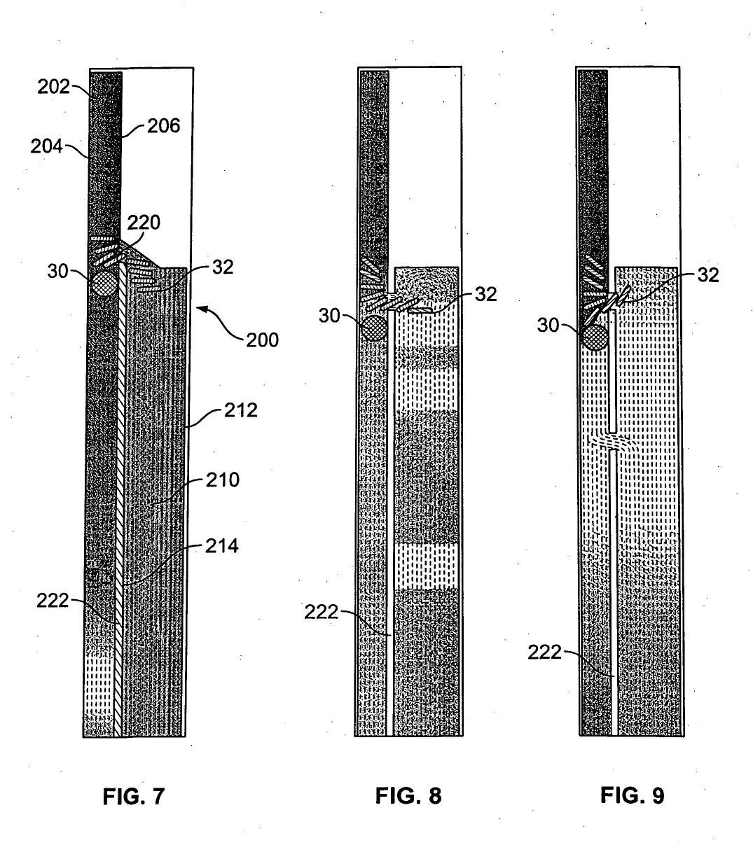

Referring to FIG. 7, a device 200 for separating WBCs from blood includes a first flow path 202 that is defined by a first pair of walls 204, 206 through which blood may flow under pressure. A second flow path 210 is defined by a second pair of walls 212, 214. The first 206 and second 210 flow paths are in fluid communication through an aperture 220 that is defined in a barrier 222 that separates the flow paths 202, 210. Aperture 220 and flow paths 202, 210 are dimensioned and configured to divert RBCs 32 into flow path 210. Aperture 220 in this particular embodiment is approximately 6 μm in size. As shown in FIG. 9, barrier 222 can include more than a single aperture, e.g., 1, 2, 5, 10, 20, 50, 100, or more apertures, e.g., 500 apertures. In addition, the location of the aperture(s) can vary from an upstream location, e.g., as shown in FIG. 7, to a more downstream location, e.g., as shown in FIGS. 8 and 9.

Referring particularly to FIG. 7, first flow path 202 is configured and dimensioned so that red blood cells 32 stack up behind white blood cell 30. Not wishing to be bound by any particular theory, it is believed that this RBC “train” formation behind a WBC occurs because RBCs move faster than WBCs, but are unable to pass the WBC. First flow path 202 is also configured and dimensioned so that when a WBC 30 flows past aperture 220, a small pressure differential, e.g., of about 0.01 to about 10 cm H₂O, e.g., 0.1 cm H₂O, 1 cm H₂O, or 5 cm H₂O, is produced between first flow path 202 and second flow path 210 proximate aperture 220. In particular, pressure in first flow path 202 proximate aperture 220 is higher than pressure in second flow path 210 proximate aperture 220 immediately after the WBC 30 flows past aperture 220, causing transfer of red blood cells 32 from first flow path 202 to second flow path 210, while excluding WBCs 30 from second path 210. This transfer of RBCs 32 from first flow path 202 to second flow path 210 enriches second flow path 210 with red blood cells 32, while depleting first flow path 202 of RBCs.

In some embodiments, a width of first flow path 202, measured between the first pair of walls 204, 206, is, e.g., within 20% (either smaller or larger) of a largest outside dimension of a white blood cell. In certain embodiments, a height of first flow path 202, measured from a floor to a ceiling of first flow path 202, is, e.g., within 20% (either smaller or larger) of a largest outside dimension of a WBC. The width and the height are dimensioned such that the passage of faster RBCs 32 by WBCs 30 is hindered. In certain instances, a width, measured between the second pair of walls 212, 214, is, e.g., 100, 200, 500, 1000 μm or more, e.g., 5000 μm.

Methods of Manufacture

In general, the devices and systems described herein can be made by a suitable microfabrication technique, for example, lithography, silicon micromachining, polymer replica molding, microprinting, and stamping. Suitable materials include polymers, e.g., a thermoplastic or a thermoset, e.g., a polysiloxane, e.g., polydimethylsiloxane (PDMS). Other suitable materials include inorganic materials, e.g., crystalline silicon, glass, metals (e.g., titanium), or composites (e.g., fiberglass).

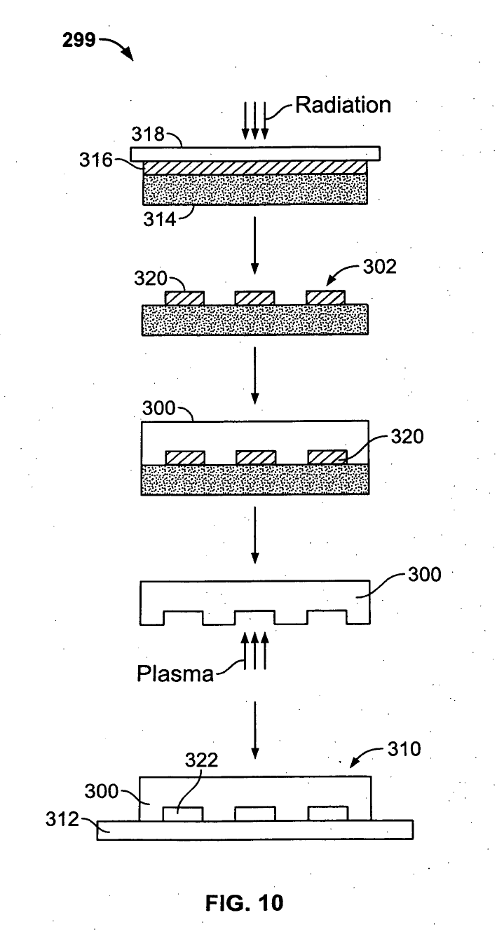

Referring to FIG. 10, a soft lithography process 299 involves production of a mold replica 300 using a negative image master 302. A microfluidic device 310 is constructed by mating mold replica 300 and a base plate 312. Mold replica 300 is made of, for example, a plastic, e.g., a thermoplastic, a vulcanate (e.g., a rubber or poly(dimethylsiloxane) (PDMS)). A negative image master 302 can be made by providing a substrate 314, e.g., a silicon material, over-coating substrate 314 with a photoresist 316, and then placing a mask 318 over photoresist 316. Photoresist 316 is crosslinked in unmasked areas using radiation, e.g., UV light. Mask 318 is removed, and then uncrosslinked photoresist is dissolved using an appropriate solvent. Etching, e.g., using reactive ion etching, followed by removal of cross-linked photoresist leaves master 302 with posts 320. These posts 320 will become flow paths 322 when master 302 is mated with base 312 to form microfluidic device 310.

In some embodiments, the plastic used for the mold is PDMS. Conveniently, a two-component system can be used, that includes a base and a curing agent. A suitable PDMS material is SYLGARD® 184 silicone elastomer kit available from Dow Corning. A variety of cure mechanisms are possible. For example, in some instances, silicon hydride groups present in the curing agent react with vinyl groups present in the base to form a cross-linked, elastomeric solid. The two parts are generally mixed together in a 10:1 (v/v) base:curing agent ratio. Pre-polymer liquid is poured over a master, and then the pre-polymer is cured. Liquid PDMS pre-polymer conforms to the shape of the master and replicates the features of the master with high fidelity. In some instances, the durometer of the resulting mold is less than about 98 Shore A, for example, less than 95 Shore A, 85, 75, 60, or less than 50 Shore A. An advantage of PDMS is that it can seal to itself, or to other surfaces, reversibly or irreversibly and without distortion of flow paths. Another advantage of using PDMS is that PMDS that has been molded against a smooth surface can conformally contact other surfaces, even if they are nonplanar, because PDMS is elastomeric. Furthermore, PDMS can be transparent for viewing into the microfluidic device.

A water-tight, reversible seal that can withstand pressures of approximately 3-8 psi can be made by contacting two portions of the molded silicon together. In some instances, tape, for example, silicone or cellophane tape can be used to reversibly seal two portions together. To form an irreversible seal, typically at least one surface of the PDMS mold is treated with an air plasma (see FIG. 10) for at least one minute. It is believed that treatment with plasma generates silanol groups (Si—OH) on the surface of the PDMS by oxidation. Surface-oxidized PDMS can seal to itself, glass, silicon, polystyrene, polyethylene, or silicon nitride, provided that these surfaces have also been exposed to an air plasma.

In a specific embodiment, a silicon wafer containing a negative image of a device was created using electron beam lithography (EBMF-10.5/CS, Cambridge Instruments, UK) and reactive ion etching (Bosch process, Unaxis SLR 770 ICP Deep Silicon Etcher, Unaxis USA Inc, St. Petersburg, Fla.) techniques. This master wafer was then used to cast replicas of the device in PDMS (RTV 615 A/B; G.E. Silicones, Waterford, N.Y.). Each cast replica was trimmed to size and affixed onto a pre-drilled, PDMS-coated glass slide (Micro Slides; VWR Scientific, West Chester, Pa.) to form a microfluidic device. Before assembly, all fluid contact surfaces were exposed to air plasma (Plasma Cleaner/Sterilizer, Harrick Scientific Corporation, Ossining, N.Y.). The assembled microfluidic devices were flushed with a 1% aqueous solution of monomethoxy-poly(ethylene glycol) silane (mPEG-silane), 5000 molecular weight, Shearwater Polymers, to prevent cell adhesion and then washed with GASP buffer (1% bovine serum albumin, 9 mM Na₂HPO₄, 1.3 mM NaH₂PO₄, 140 mM NaCl, 5.5 mM glucose, pH 7.4, osmolarity 290 mmol/kg).

Additional details of suitable microfabrication techniques can be found in articles by Shevkoplyas et al., Microvas. Res. 65, 132-136 (2003), Gifford et al., Biophys. J. 84, 623-633 (2003), Shevkoplyas et al., Analytical Chemistry, 77 (3), 933-937 (2005), and and Whitesides et al., Accts. Chem. Res. 35, 491-499 (2002).

Separating Systems

Systems can be fabricated, for example, from any combination of the above-mentioned devices, or portions of the above-mentioned devices, so that particles of different sizes, e.g., red and white blood cells, can be easily separated from each other. Some other devices that may be incorporated into such systems that have not been discussed above will be discussed below. In some cases, the systems are fabricated with multiple devices in series, and can provide a higher level of enrichment of particles than the devices described above. In some instances, the systems are fabricated with multiple devices in parallel, for example, to allow processing of larger quantities of fluid. In still other embodiments, systems can be fabricated so that portions of the system are configured so that the individual devices are arranged in series and portions are arranged in parallel.

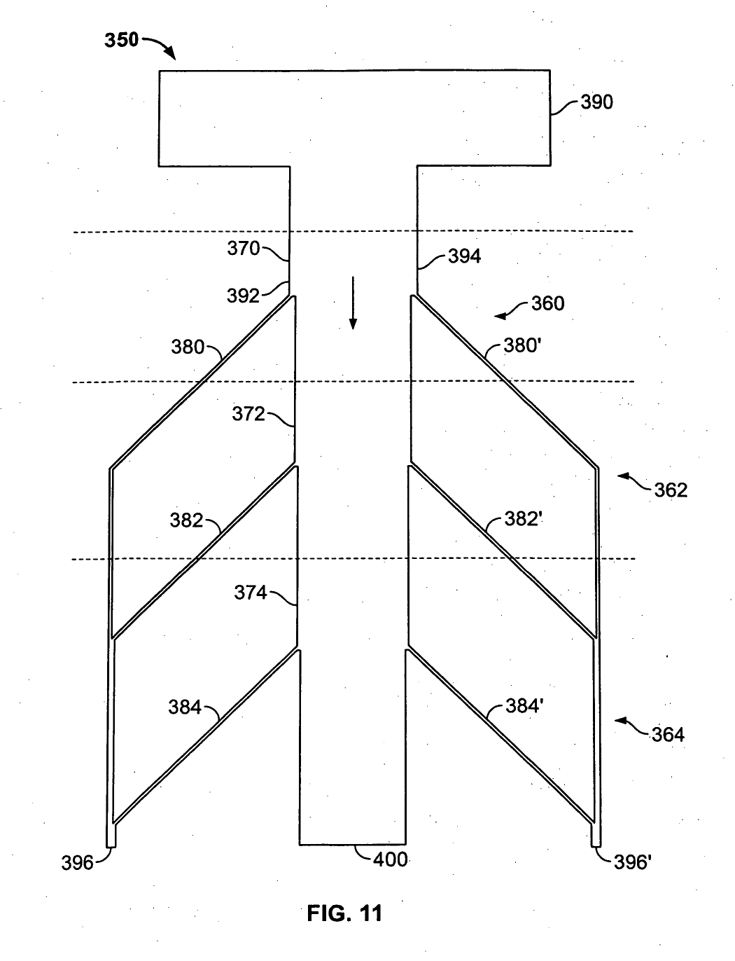

Referring now to FIG. 11, a system 350 includes three individual devices, 360, 362, and 364, connected in series such that each first flow path 370, 372, and 374 is in fluid communication with the first flow path of an adjacent device. Each device has two second flow paths disposed on opposite sides of the device, creating a symmetric network of flow paths. Each second flow path, 380 (380′), 382 (382′) and 384 (384′) of each device is in fluid communication with a second flow path of an adjacent device. The network of flow paths in device 350 is configured and dimensioned such that margination of WBCs occurs towards walls of each of the first flow paths. Each of the second flow paths are configured and dimensioned to capture the marginated WBCs. In this particular embodiment, the height of all flow paths is from about 10 μm to about 12 μm, and an overall length of device 350 is approximately 1 cm.

Briefly, blood enters system 350 from reservoir 390 into first flow path 370 of device 360. In this particular embodiment, first flow path 370 has a width of about 200 μm. Once in first flow path 370, margination of WBCs occurs towards walls 392, 394. Second flow paths 380 (380′) are configured and dimensioned to capture the marginated white blood cells, similar to that described in reference to FIGS. 1-6. In this particular case, second flow paths 380 (380′) are approximately 10 μm in width. Downstream from an entrance to second flow path 380 (380′), first flow path 370 narrows to about 180 μm. This narrowing keeps a higher pressure upstream so that the WBCs can flow through upstream paths. Blood continues downstream and is depleted further along each segment of more and more of its WBCs. Second flow paths combine such that outputs 396 (396′) are enriched in WBCs, while output 400 is depleted in white blood cells, and, therefore enriched in red blood cells. In this particular example, outputs 396 (396′) are 30 μm in width and output 400 is 140 μm in width.

The system of FIG. 11 may optionally include a device or devices in which flow paths are arranged such that one flow path is configured to exclude white and RBCs, while allowing blood plasma and platelets to continue on the path.

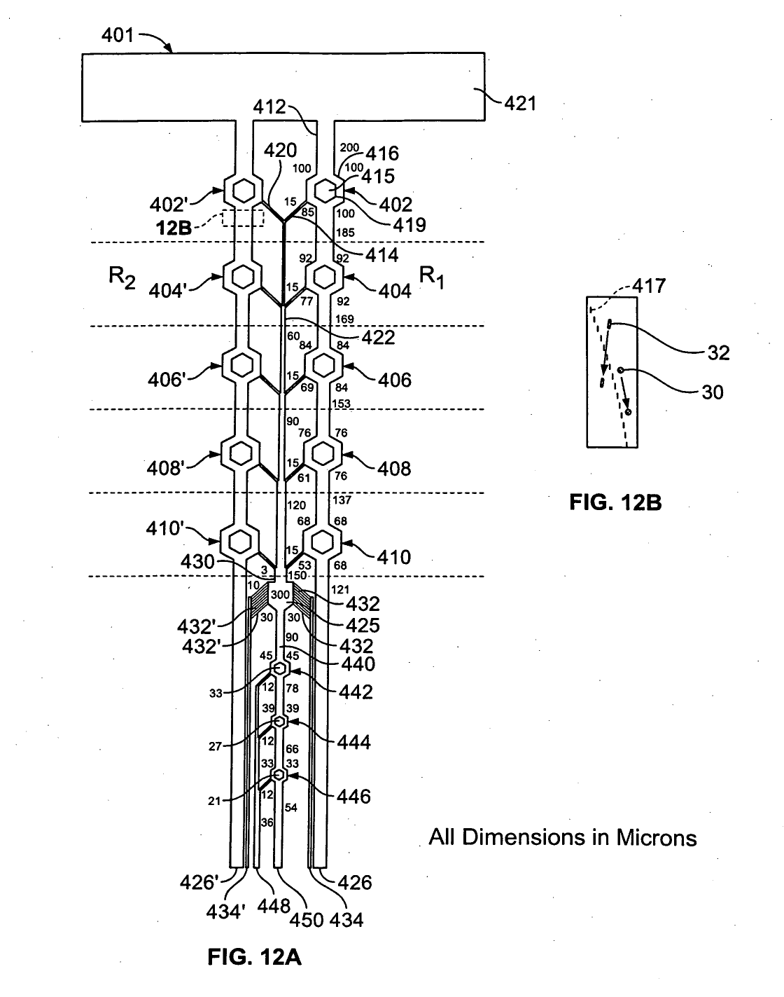

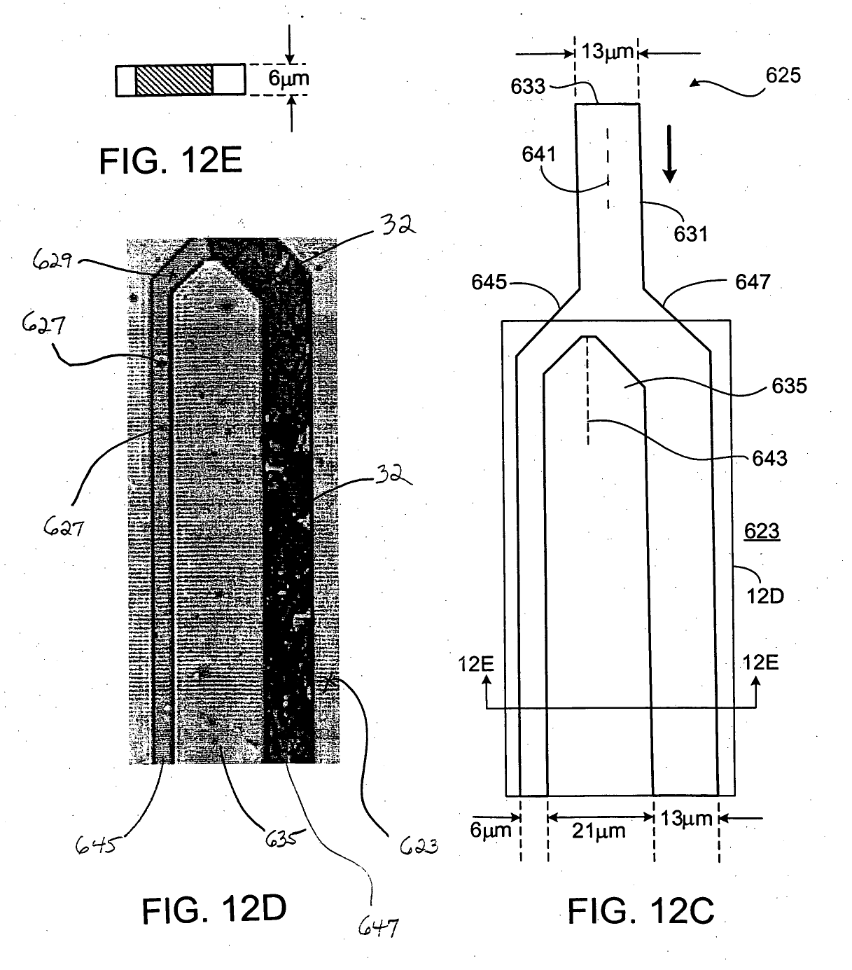

Referring now to FIG. 12A, a system 401 includes two rows of devices R₁ (devices 402-410) and R₂ (devices 402′-410′) arranged in series. Each device in each row has a corresponding parallel device, for example, the pair 402, 402′. It can be desirable to arrange devices in series to improve the level of separation, and in parallel to allow for processing larger quantities of blood. Combining devices both in series and in parallel enables a simultaneous improvement in separation efficiency and processing of larger quantities of blood. Similar to the device of FIG. 3, each device 402-410 and 402′-410′ includes a first flow path (e.g., 412) defined by a first pair of walls through which blood may flow under pressure. A second flow path (e.g., 414) is defined by a second pair of walls that is in fluid communication with the first flow path. The first flow path is configured such that margination of WBCs occurs toward the first pair of walls, and the second flow path is configured to capture the marginated WBCs.

Referring particularly to FIG. 12B, some or all of the first flow paths can include rectangular projections 417 that are parallel to walls. The dimensions between adjacent projections is such that RBCs 32 can freely pass therebetween, but straight, forward motion of white blood cells 30 is hindered. WBCs are typically not trapped between these obstacles, but rather are diverted by them towards sidewalls. Projections 417 can increase the rate of margination of WBCs towards sidewalls. Projections 417 can also be arranged such that they facilitate margination of WBCs towards both sidewalls equally. Projection 415 bifurcates first flow path 412, thereby defining a third flow path 416. Such a bifurcation is often advantageous to increase WBC extraction efficiency by second flow paths, e.g., 414, and, therefore, to increase separation efficiency. The first flow path and third flow path 416 recombine proximate a downstream portion 419 of projection 415. The devices of each row R₁ and R₂ are arranged in series, such that the first flow path of each device is in fluid communication with the first flow path of an adjacent device, e.g., device 402 and 404, and the second flow path of each device is in fluid communication with the second flow path of an adjacent device. Each device, e.g., 402, is also in fluid communication with a parallel device, e.g., 402′, through second flow paths, e.g., 414 and 420. In this particular embodiment, the height of all flow paths is from about 10 μm to about 12 μm. An overall length of device 401 is approximately 5 cm.

Briefly, in operation, blood enters system 401 from feeding reservoir 421 and flows into rows R₁, R₂. In this particular embodiment, the first flow path of each parallel device 402, 402′ has a width of about 200 μm. Once in the first flow path of each parallel device 402, 402′, margination of white blood cells occurs toward sidewalls of each device. Second flow paths 414, 420 are configured and dimensioned to capture the marginated WBCs, similar to that described in reference to FIGS. 1-6. In this particular case, second flow paths 414, 420 are approximately 15 μm in width. Downstream from a start of the second flow paths, the first flow path of each device narrows to approximately 185 μm, and continues to narrow, moving downstream to 169 μm, 152 μm, 137 μm, and finally to 121 μm just upstream from concentrator 425. Each sequential narrowing of a first flow path, e.g., 412, combined with a corresponding projection, e.g., 415, and a corresponding second flow path, e.g., 414, constitutes a device, e.g., 402, 404, 406, 408 and 410. This narrowing maintains a higher pressure upstream so that the WBCs can flow through a side path, e.g., 420. The second flow path of each device is in fluid communication through a combined flow path 422, whose width increases moving downstream from 30 μm, to 60 μm, to 90 μm, to 120 μm, and to 150 μm just upstream from concentrator 425.

Effluent in outputs 426 and 426′ is substantially depleted of WBCs, i.e., enriched in RBCs.

Referring particularly to concentrator 425, an input 430 includes plasma enriched in WBCs with some RBCs. Concentrator 425 includes a plurality of flow paths 432 (432′) on opposite sides of concentrator 425 arranged and dimensioned so as to exclude white and red blood cells, while allowing blood plasma and platelets to continue on the path. The net result of concentrator 425 is to create parallel paths 434 and 434′, effluents of which contain mostly plasma and platelets, and that are depleted of white and RBCs. In addition, the output from concentrator 425 includes a flow path 440, effluent of which contains higher concentrations of white and RBCs compared with the influent entering concentrator 425 via inlet 430. Output 440 is fed to a series of devices 442, 444, and 446. Each device includes a first flow path that is configured and dimensioned such that margination of white blood cells occurs towards walls of each of the first flow paths. Each device also includes a second flow path that is configured and dimensioned to capture the marginated white blood cells. This results in an output 448 that is highly enriched with WBCs and highly depleted of RBCs, and an output 450 which is enriched with RBCs (relative to 448) and depleted of WBCs.

Platelets can be separated from a stream having RBCs, platelets and plasma. For example, referring to FIGS. 12C, 12D, and 12E, a device 625 for separating platelets 627 from a stream that includes plasma 629, RBCs 32, and platelets 627 is fabricated in a substrate 623, e.g., by any one of the methods described herein. Device 625 includes a first flow path 631 having an inlet 633. First flow path 631 is asymmetrically bifurcated by a projection 635, i.e., a centerline 641 of first flow path 631 and a centerline 643 of projection 635 are not in line with one another, forming a second flow path 645, and a third flow path 647 larger than the second flow path. By configuring flow paths 645 and 647 appropriately, an essentially pure stream of platelets 627 in plasma can be skimmed from the stream having the RBCs, platelets and plasma. In the particular embodiment shown in FIG. 12C, the height of each channel is approximately 6 μm; centerlines 641 and 643 of projection 635 are offset by approximately 6 μm, producing the second flow path having a width that is approximately 6 μm, and the third flow path having a width of that is approximately 13 μm. Without wishing to be bound by any particular theory, it is believed that the platelets can be separated from the RBCs because the RBCs are highly deformable and migrate from high shear regions near the walls into the center of the stream. This results in the formation of a plasma and platelet-rich (RBC depleted) zone near the walls. The volumetric flow rate through the device is such that path 647 receives the majority of total flow from path 633. Path 645 receives much less flow, and so its contents are primarily from the plasma-rich zone near the sidewall of the path 633.

Platelets can also be separated from a stream of whole blood.

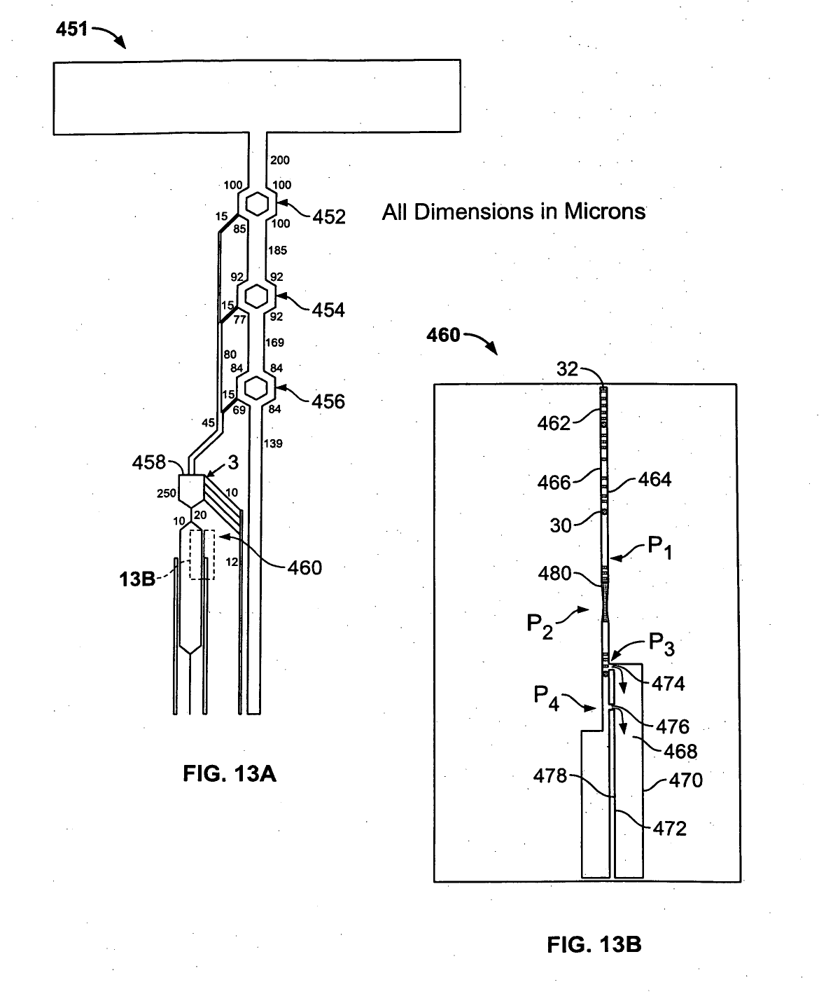

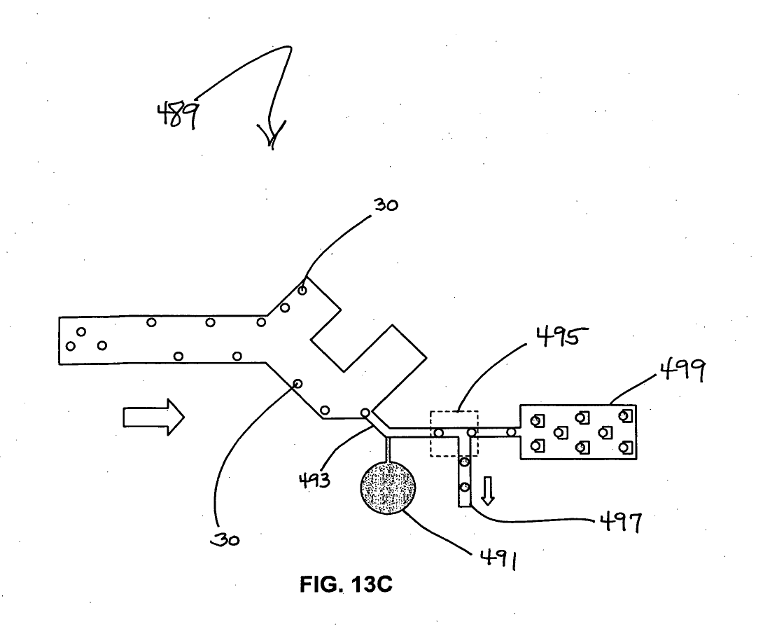

Referring to FIGS. 13A-13B, a system 451 includes a plurality of devices 452, 454, 456 arranged in series. Each device includes a flow path that is configured such that margination of WBCs occurs towards walls, and another flow path that is configured and dimensioned to capture the marginated WBCs. In this particular embodiment, each first flow path of each subsequent device narrows from 200 μm in an upstream portion, to 185 μm, to 169 μm, and finally to 139 μm in a downstream portion. The narrowing maintains a constant cumulative cross-sectional area across the device, which equalizes the flow rates throughout. System 451 also includes a concentrator 458 in which flow paths are arranged to exclude white and RBCs, while allowing blood plasma and platelets to continue on the path, resulting in streams that are enriched in platelets.

Referring now particularly to FIG. 13B, system 451 also includes a device 460 that includes a first flow path 462 that is defined by a first pair of walls 464, 466 through which blood may flow under pressure. A second flow path 468 is defined by a second pair of walls 470, 472. The first 462 and second 468 flow paths are in fluid communication through apertures 474, 476 that are defined in barrier 478 that separates flow paths 462, 468. Apertures 474, 476 are dimensioned and configured to exclude white blood cells 30, while allowing RBCs 32 to pass therethrough, as described above in reference to FIGS. 7-9. As blood enters flow path 462, which has a nominal width at P₁ of approximately 13 μm, RBCs and WBCs are randomly spaced apart along flow path 462. Flow path 462 includes a constriction 480 in which a width of the flow path 462 narrows from an upstream portion. In this particular embodiment, a width of flow path 462 narrows continuously from a nominal width, e.g., 13 μm at P₁, to a minimum width, e.g., 11 μm at P₂ and then widens again back to a nominal width of the flow path at an downstream portion, e.g. 13 μm at P₄. Having constriction 480 encourages a closer spacing between the white and red blood cells. In some implementations, this allows for a more efficient transfer of RBCs 32 from first flow path 462 to second flow path 470, while excluding WBCs 30 from second path 470.

Particles Other than Red and White Blood Cells

Any of the devices, systems, or methods described above can be used to separate particles other than RBCs or WBCs, when such devices, or systems are appropriately sized. For example, the margination devices of FIGS. 1-6, the sorting devices of FIGS. 7-9, and the systems of FIGS. 11-13 can be used to separate various types of particles.

Other particles can be, e.g., platelets, polymeric particles (e.g., hydrogel particles such as polyHEMA), particles derived from a copolymer of methacrylamide, N,N′-methylene-bis(acrylamide) and a monomer carrying oxirane groups, melamine-formaldehyde resin microparticles, microparticles of degradable polymers such as polylactic acid microparticles, polymethacrylate microparticles, or polystyrene microparticles). Other particles can be magnetic particles, e.g., amine-terminated magnetic particles, or carboxy-terminated magnetic particles. Inorganic particles include (e.g., ceramics such as boron nitride, or silicon carbide, aluminum oxide nanoparticles, silicon dioxide microparticles, quartz micro and nano particles), metals (e.g., iron, or titanium particles), metal oxides (e.g., cerium (IV) oxide nanoparticles), or elemental particles (e.g., iodine). Composite particles include, e.g., silica particles coated with polyvinyl-pyrrolidone. Biological particles include, e.g., plasmids, proteins or nucleic acids (e.g., DNA, RNA), cells (e.g., stems cells), biological macromolecules, or food products (e.g., seeds, bean and nuts).

The liquid can be any liquid, e.g., water, water made viscous by adding a soluble polymer, an alcohol, a hydrocarbon solvent, an ester solvent, or a chlorinated solvent.

Margination devices similar to that shown in FIG. 1 can be used to separate first particles from a suspension of particles in a liquid.

The first particles can be flexible, or rigid. Rigid particles are those that are generally difficult to distort under a compressive load, for example, particles made from a material that has a Shore A hardness of greater than about 100 or 95. Examples of rigid particles include polystyrene particles, polymethylmethacrylate particles, and glass particles. Flexible particles are those that are, generally, easily distorted under a compressive load, for example, particles made from a material that has a Shore A hardness of less than about 100, e.g., 95, 65 or less than 50 Shore A. Examples of flexible particles include hydrogels and elastomers.

When the first particles are flexible, in some embodiments, a height of the first flow path, measured from a ceiling to a floor of the first flow path, is, e.g., up to about 30% smaller than the largest outside dimension of the first particles.

When the first particles are rigid, a height of the first flow path, measured from a ceiling to a floor of the first flow path, is about equal to a largest outside dimension of the first particles to about two times larger than the largest outside dimension of the first particles.

A distance from an inlet of the first flow path to a start of the second flow path is sufficient to allow margination of the first particles. For example, when the particles being separated have a largest dimension of from 30 nm to about 200 nm, a useful distance is from about 4 mm to about 8 mm. When the particles being separated have a largest dimension of from 200 nm to about 500 nm, a useful distance is, e.g., from about 1 mm to about 4 mm. When the particles being separated have a largest dimension of from about 500 nm to about 1000 nm (i.e., 1 μm), a useful distance is, e.g., from about 0.5 mm to about 2 mm.

A width of the first flow path depends upon the largest dimension of the particle being separated. Generally, a width of from about 2 times to about 30 times the largest dimension of the particle is useful. For example, for 10 μm particles, a useful width is from about 20 μm to about 300 μm. For 7 μm particles, a useful width is from about 14 μm to about 210 μm, and for 0.7 μm particles, a useful width is from about 1.4 μm to about 21 μm.

Once first particles have been separated from a suspension of particles in a liquid, second particles can be separated from the suspension of particles by feeding the effluent of the first separation to an appropriately sized device. This process can be repeated in an analogous manner until a polydisperse sample of particles is separated into a number of monodisperse samples of particles.

Sorting devices similar to that shown in FIGS. 7-9 can be used to separate first particles from a suspension of particles in a liquid. These devices include a first flow path through which the suspension of particles in the liquid may flow under pressure. A second flow path is in fluid communication with the first flow path, and a barrier separates the first and second flow paths. The barrier includes an aperture configured to exclude the first particles, while allowing other particles to pass therethrough.

Once first particles have been separated from a suspension of particles in a liquid, second particles can be separated from the suspension of particles by feeding the effluent of the first separation to an appropriately sized device. This process can be repeated in an analogous manner until a polydisperse sample of particles is separated into a number of monodisperse samples of particles.

Applications

Many of the devices and systems described herein can be used individually, or as integrated components for other “lab-on-a-chip” microanalytical devices. As such, the systems and devices can provide an inexpensive, portable, and miniaturized tool, e.g., that occupies 10 mm² of space or less on a substrate, for selective enrichment of particles, e.g., blood constituents, e.g., red blood cells, white blood cells or platelets. Such small devices require only a small amount of sample, e.g., blood, e.g., less than 100 μl, e.g., 75 μl, 50 μl, 35 μl, or even less than 10 μl. With parallel constructions, the devices and/or systems can be used to process large quantities of sample, e.g., blood, for example, for use in leukopheresis.

When used as a medical device, the devices and/or systems can be employed externally of a human body, or can be employed internally as an implantable medical device for continuous extraction of certain particle types, e.g., cell types (e.g., circulating stem cells, cancer cells, or leukocytes). Since only a small volume of a sample, e.g., blood, is needed, e.g., 10 μL, at small flow rates, e.g., 0.5 nL/s, devices can be attached to a human or animal subject through a small catheter. In some embodiments, connecting a device and/or system to a subject's circulation system can eliminate the need for an external pressure source.

Such systems and devices can be used in analysis of WBCs, or their genetic material, e.g., DNA or RNA. Additional applications include hematologic testing, for example, hemoglobin, hematocrit, total RBC count, total WBC count, total platelet count, differential WBC count and calculated RBC indices. When such devices and systems are used with a real time imaging system, e.g., a photographic imaging system like that described below in Examples, they can be used to determine RBC morphology, reticulocyte counts, and neutrophil maturation.

Particles can also be separated from each other for manufacturing purposes. For example, different size fragments of DNA can be separated from each other, e.g., fractionated. Also, for example, polydisperse inorganic particles, e.g., ceramic particles, or polydisperse polymeric particles, e.g., degradable, or non-degradable polymeric particles, can be separated, e.g., fractionated, from each other to prepare particles having a monodisperse, or nearly a monodisperse size distribution.

A WBC separation unit can be, e.g., combined with a variety of post-processing and/or analytical units downstream of separation. For example, referring to FIG. 13C, a WBC separation unit 489 can include a labeling portion 491 that introduces a marker, e.g., a fluorescent to a stream 493 of separated WBCs. The marker, e.g., a fluorescent antibody configured to specifically bind to a complementary site on the WBC 30, binds to the white blood cells, and then the WBCs can be imaged using an imaging device 495, e.g., an inverted optical microscope capable of collecting data from the marked cells. Imaging such cells enables sorting based on the data collected during the imaging. Extraction of desired cells into collection channel 497 can be accomplished by, e.g., a pressure differential or by electro-osmotic flow, e.g., controlled by platinum electrodes. If desired, separation unit 489 can also include analytical units 499, e.g., for genetic testing of the separated cells.

In a particular embodiment, a fluorescent antibody is utilized. Separating device 489 is mounted on an inverted microscope, and fluorescence is stimulated near a junction of channel 493 and collection channel 497 using a laser, e.g., a Coherent Innova Ar Laser operating at 488 nm. The light emitted is collected by the microscope and amplified with a photo-multiplier tube (PMT). A computer digitizes the PMT signal and controls flow into the collection channel by electro-osmotic potentials. A fluorescence-activated cell sorter can be used to remove specific cells or particles from the system (see, e.g., Fu, Nature Biotechnology, 17:1109-1111, 1999). Observation can enable active extraction, e.g., using a vacuum source, e.g., a pipette, and an extraction channel 497 to remove the observed cells. If desired, the separation unit 489 can also include analytical units 499, e.g., for genetic testing of the separated cells.

Other markers include, e.g., magnetic markers that can specifically tag a subgroup of interest within the separated WBC population. For example, Berger, Electrophoresis 22, 3883-3892 (2001) describes magnetic markers.

Cells can also be immobilized in any portion of the device for later analysis. Cells can be immobilized by any known methods, e.g., as described in Gifford, Biophysical Journal 84, 623-633 (2003).

### EXAMPLES

The invention is further described in the following example, which does not limit the scope of the invention described in the claims.

Whole human blood was collected by venipuncture from healthy consenting volunteers into Vacutaner tubes containing EDTA (10 ml, 17.55 mg (K3) EDTA, BD, Franklin Lakes, N.J.). The initial red and white blood cell concentrations in the whole blood were determined using Sysmex K-1000 automated cell counter (Sysmex Corp. of America, Long Grove, Ill.) in duplicate. Blood samples were then used directly without additional handling or pre-processing within 4 hrs after collection.

### Example 1

### Photographic Real Time Monitoring of Blood

Providing photographic real time data on blood as it passes through or circulates in a separating device and/or system can be useful as a diagnostic tool, or to optimize and trouble-shoot a device or system before mass-producing the device or system.

Referring to FIGS. 14 and 14A, and also to FIG. 6A, an apparatus 500 for real time monitoring of blood includes a holder 502 on a calibrated, motorized microscope stage 504 (BX-51, Olympus America, Inc, Melville, N.Y.). A water column 510 was used to provide an operational pressure gradient of approximately 40 cm H₂O to device 100 positioned on glass support 520 that had been coated with PDMS. A blood sample 501 was delivered to an inlet 110. Blood flows under pressure from inlet 110 to a combined single outlet 514. Images were acquired with a CMOS digital camera 530 (Silicon Video 2112, Epix Inc, Buffalo Grove, Ill.) using a wide bandpass blue-violet filter 532 (407±52 nm, Edmund Industrial Optics, Barrington, N.J.) to improve contrast. Images 540 were visualized and recorded using a monitor 534 interfaced to a computer 536. Captured images 540 were analyzed off-line using software that was designed using Matlab 6.5 (The Math Works, Natick, Mass.). Analysis of captured images was used to determine WBC distributions and the WBC-to-RBC ratio in a particular flow path. The apparatus 500 had a constant flow path height of approximately 10.3 μm. The blood sample 501 was introduced into a feeding reservoir cut in a PDMS replica to provide access to the flow paths before assembly. Outlet 514 through which blood exited apparatus 500 was created through a 2-mm hole drilled through glass slide 520 and then the blood drained through a 60-cm-long plastic tube 550 connected to a waste collection reservoir. In this particular configuration, 15 to 70 μl of blood is needed for operation.

### Example 2

### Separation Through an Aperture

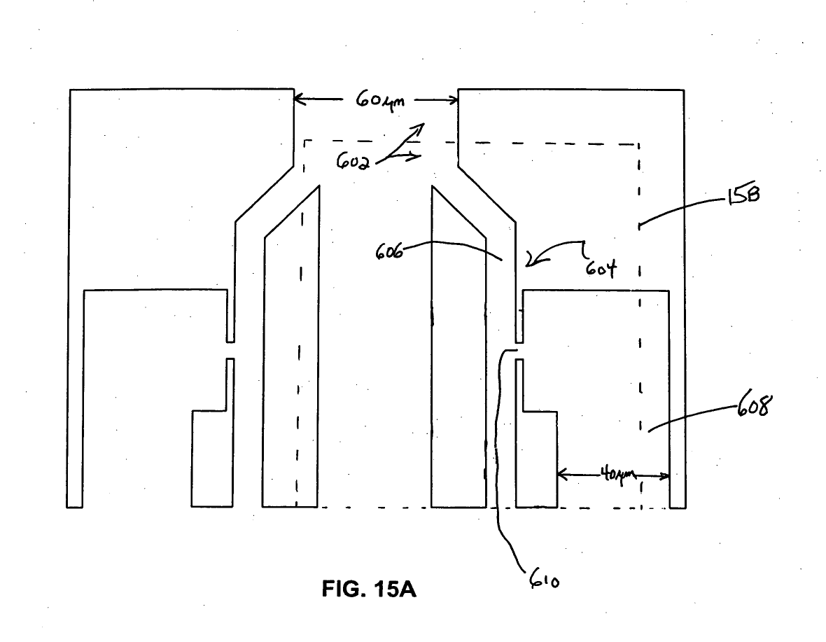

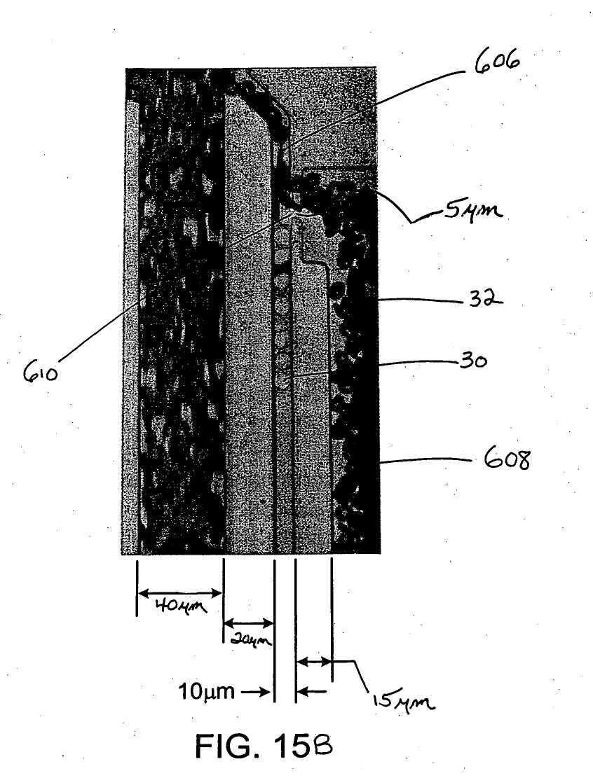

Referring to FIG. 15A, a device 600 for separating WBCs from blood includes a first portion 602 that is configured and dimensioned to induce margination of WBCs and to capture the marginated WBCs, and a second portion 604 in which a first flow path 606 and a second flow path 608 are in fluid communication through an aperture 610 that is configured to exclude white blood cells. Referring now to FIG. 15B, the second portion 604 of the system efficiently separates RBCs 32 from a flow pathway containing both RBCs 32 and WBCs 30 when the aperture is approximately 5 μm wide, the first flow path 606 is 10 μm wide, the second flow path is 40 μm wide, and the height of each flow pathway is 10-11 μm. Such a configuration can reduce the RBC concentration in first flow pathway 606, downstream of the aperture 610.

### Other Embodiments

A number of embodiments of the invention have been described. Nevertheless, it will be understood that various modifications may be made without departing from the spirit and scope of the invention.

For example, while each device of FIG. 12, e.g., device 404, has only a single flow path on one side of the device dimensioned and configured to capture marginated white blood cells, the device can have more, e.g., 2, 3, 5 or more, e.g., 10, on one side of the device to capture marginated WBCs. In addition, the devices of FIG. 12 can have flow paths on both sides to capture marginated WBCs.

Blood can travel through a device and/or a system in a single pass or in multiple passes. Blood can also continuously circulate in a device and/or system. Blood can be supplied via an inlet or inlets before, during and/or after circulation. Intermittent and/or continuous circulation of blood in a device and/or system can alternate with intermittent and/or continuous circulation of other liquids, e.g., buffer solutions, plasma, or water.

While the devices and/or systems work with human blood, they also work with blood from other animals, e.g., other mammals, provided that flow paths are configured and dimensioned appropriately. The devices and/or systems can work with various suspensions of blood cells in appropriate suspending liquids, e.g., buffers. While the devices and/or systems work with whole, undiluted, unmodified human blood, they also work with various suspensions of modified cells, e.g., cells labeled with fluorescent stain, cells labeled with fluorescent particles, or cells labeled with magnetic particles.

Devices and/or systems described herein can be operated in batch mode, or in continuous mode, e.g., 24 hours a day, seven days a week.

Devices described herein can operate under normal gravity, i.e., gravity experienced on Earth, less than normal gravity, e.g., gravity experienced during space travel, or greater than normal gravity, e.g., two, three, or more, e.g., five times normal gravity.

A filter, e.g., configured to remove components of blood, e.g., platelets, can be used in conjunction with the devices and/or systems described herein.

While flow paths have been described having rectangular transverse cross-sections, others transverse cross-sections are possible. For example, circular, or polygonal, e.g., hexagonal, are possible.

Flow paths can be coated, for example, to reduce flow resistance, or to reduce the likelihood of blood coagulation. For example, heparin can be grafted onto a surface of a flow path to prevent coagulation.

While devices, systems and methods for separating white blood cells, red blood cells and platelets from blood have been described, the WBCs, RBCs or platelets can be suspended in a liquid other than blood, e.g., serum, saline, or plasma.

Still other embodiments are within the claims.

What we claim is:

1. A device for separating first particles from a suspension of particles in a liquid, comprising:
a first flow path defined by a first pair of walls through which the suspension of particles in the liquid may flow; and
a second flow path defined by a second pair of walls that is in fluid communication with the first flow path,
wherein the first flow path is configured and dimensioned such that margination of the first particles occurs towards the first pair of walls, and wherein the second flow path is configured to capture the marginated first particles.

2. The device of claim 1, wherein a distance from a start of the first flow path to a start of the second flow path is from about 100 μm to about 25 cm.

3. The device of claim 1, wherein a width of the first flow path, measured between the first pair of walls is from about 10 μm to about 10 mm.

4. The device of claim 1, wherein a height of the first flow path, measured from a ceiling to a floor of the first flow path, is up to about 75% larger than an average outside dimension of a first particle.

5. The device of claim 1, wherein the height within about 30% of an average outside dimension of the first particle.

6. The device of claim 1, wherein a height of the first flow path, measured from a ceiling to a floor of the first flow path, is substantially equivalent to a largest outside dimension of a first particle.

7. The device of claim 1, wherein a width of the second flow path, measured between the second pair of walls, is within 20% of a largest outside dimension of a first particle.

8. The device of claim 1, wherein the first flow path is substantially straight along its entire length.

9. The device of claim 1, wherein the first flow path includes a turn along a portion of its length.

10. The device of claim 1, wherein the first flow path comprises a bend of from about 90 to about 180 degrees, measured from a central longitudinal axis of the flow path upstream and downstream of the bend.

11. The device of claim 1, wherein the second flow path is substantially straight along its entire length.

12. The device of claim 1, wherein the second flow path includes a bend along a portion of its length.

13. The device of claim 1, wherein a flow path includes a projection

14. The device of claim 13, wherein the projection is circular in cross-section when viewed from above.

15. The device of claim 13, wherein the projection bifurcates the flow path.

16. The device of claim 1, wherein an upstream portion of one of the second pair of walls of the second flow path tapers, forming a tip proximate an entrance of the second flow path.

17. The device of claim 1, wherein one of the second pair of walls of the second flow path includes an aperture defined therethrough such that the first flow path and the second flow path are in fluid communication through the aperture.

18. The device of claim 1, wherein the second flow path includes a constriction in which a width of the second flow path narrows from an upstream portion to a downstream portion.

19. The device of claim 1, wherein the second flow path includes a constriction in which a width of the second flow path narrows continuously from a nominal width at an upstream portion to a minimum width, and then widens back to the nominal width of the second flow path at a downstream portion.

20. The device of claim 18, wherein the constriction is proximate an aperture.

21. The device of claim 1, wherein the first and second flow paths are formed in a substrate that comprises a polymeric material.

22. The device of claim 21, wherein the polymeric material comprises a poly(siloxane).

23. An apparatus for separating cells from blood products, comprising a plurality of devices of claim 1 arranged in series, such that a first flow path of each device is in fluid communication with a first flow path of an adjacent device, and a second flow path of each device is in fluid communication with a second flow path of an adjacent device.

24. An apparatus for separating blood, comprising a plurality of devices according to claim 1 arranged in parallel.

25. A device for separating first particles from a suspension of particles in a liquid:
a first flow path through which the suspension of particles may flow;
a second flow path that is in fluid communication with the first flow path; and
a barrier that separates the first and second flow paths comprising an aperture defined therein that is configured to exclude the first particles,
wherein the first flow path is has a height, measured from a ceiling to a floor of the first flow path and a width, measured between walls of the first flow path that is within 30% of an average largest outside dimension of the first particles.

26. The device of claim 25, wherein the barrier includes a plurality of apertures defined thererin.

27. A device for separating a liquid from particles suspended in the liquid, comprising:
a first flow path defined by a first pair of walls through which particles suspended in the liquid may flow; and
a plurality of second flow paths extending from walls of the first flow path, each second flow path defined by a second pair of walls,
wherein each second flow path is in fluid communication with the first flow path, and wherein each second flow path has a width, measured between the second pair of walls, that is smaller than a dimension of a smallest particle in the suspension.

28. A method for separating first particles from a suspension of particles in a liquid, the method comprising:
providing the device of claim 1; and
delivering a suspension of particles in the liquid under pressure to the first flow path.

29. The method of claim 28, wherein the liquid is blood plasma, and wherein the first particles are white blood cells.

30. A method for separating first particles from a suspension of particles in a liquid, the method comprising:
providing the device of claim 25; and
delivering the suspension of particles in the liquid to the first flow path.

31. The method of claim 30, wherein the liquid is blood plasma, and wherein the first particles are white blood cells.

32. A method of separating a liquid from a suspension of particles in the liquid, the method comprising:
providing the device of claim 27; and
delivering a suspension of particles in a liquid to the first flow path.

33. The method of claim 32, wherein the liquid is blood plasma, and wherein the particles are cellular components of blood.
